(19) United States
(12) Patent Application Publication
(10) Pub. No.: US 2013/0105349 A1
(43) Pub. Date: May 2, 2013

(54) Mailing Tube With Removeable Decoration

(71) Applicants: Renata Regina Lafler, Woodridge, IL (US); Jason Michael Lafler, Woodridge, IL (US)

(72) Inventors: Renata Regina Lafler, Woodridge, IL (US); Jason Michael Lafler, Woodridge, IL (US)

(21) Appl. No.: 13/286,993

(22) Filed: Nov. 1, 2011

(51) Int. Cl. B65D 59/02; B23P 19/00

(52) U.S. Cl. 206/457; 29/428

(57) ABSTRACT

A mailing tube plug which has a removable decorative component which can be disengaged from the mailing tube plug and displayed separately from the mailing tube plug. The mailing tube plug has an ornament engagement end. The ornament engagement end has an ornament receiving region which is a recessed region for receiving at least a portion of the ornament. The recessed region is complementarily shaped to a portion of the ornament to receive a portion of the ornament. The mailing tube plug has a central shaft. The ornament is connected to an ornament attachment device, such as a looped string, which is strung through the central shaft. Pulling the ornament attachment device through the shaft presses the ornament against the recessed region. The free end of the ornament attachment device is itself secured such that the ornament is not loosened from its position within the ornament receiving region during mailing.

### FIELD OF THE INVENTION

This invention relates in general mailing tubes, and more particularly to mailing tube plugs.

### BACKGROUND OF THE INVENTION

Mailing tubes are known packaging enclosures used for the packaging and mailing of large flexible sheets of paper, poster paper, fabric, and the like that are better suited for mailing when rolled up.

Typical mailing tubes comprise a compartment for holding the rolled up member, and is dosed on one end to prevent the contents from falling out, and open on the other end to receive a removable plug such that the contents can be accessed.

The present inventors have recognized the need for a more useful mailing tube plug, which can serve more than one purpose.

The present inventors have recognized the need for a mailing tube plug with a decorative component which can be displayed separately from the mailing tube and the mailing tube plug.

The present inventors have recognized the need for a mailing tube plug with a removable decorative component.

### SUMMARY OF THE INVENTION

The present invention provides a mailing tube plug which has a removable decorative component. The mailing tube plug has a mailing tube plug end and an ornament receiving end. The mailing tube plug end fits securely within the mailing tube to prevent the mailing tube plug, and the contents of the mailing tube, from falling out. The mailing tube plug end is configured to fit within the cross sectional area of the mailing tube. The mailing tube plug end can be secured to the open end of the mailing tube through a fitted connection, or by a threaded connection. The mailing tube, and accordingly the nailing tube plug, can be of any cross sectional shape.

On the opposite end of the mailing tube plug end is an ornament engagement end. The ornament engagement end comprises an ornament receiving region which is a recessed region for receiving at least a portion of the ornament. In one embodiment, the recessed region is complementarily shaped to a portion of the ornament to receive a portion of the ornament. In another embodiment, the recessed region is of sufficient size and shape to receive a portion of the ornament.

The mailing tube plug further comprises a central shaft. The ornament is connected to an ornament attachment device, such as a looped string, which is strung through the central shaft. Pulling the ornament attachment device through the shaft presses the ornament against the recessed region.

The free end of the ornament attachment device is itself secured such that the ornament is not loosened from its position within the ornament receiving region.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a perspective view of one exemplary embodiment of the invention.

FIG. 2 illustrates a perspective view of one exemplary embodiment of the invention with the mailing tube removed for clarity.

FIG. 3 illustrates an exploded view of one exemplary embodiment of the invention.

FIG. 4 illustrates a side view of one embodiment of the invention.

FIG. 5 illustrates a side view of an alternate embodiment of the invention

FIG. 6 illustrates a side view of an alternate embodiment of the invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

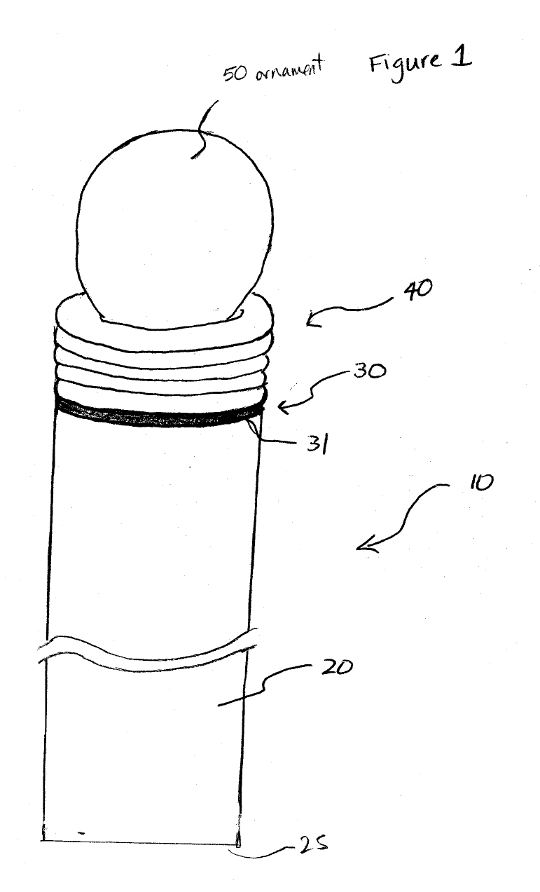

FIG. 1 illustrates a mailing tube 10 with a mailing tube plug 40 having a decorative component, such as an ornament 50. The mailing tube 10 has an open end 30 and an opposite closed end 25. The open end 30 is an end through which contents are placed within the mailing tube body 20. The open end 30 of the mailing tube may also have a lip 31 at the opening.

FIG. 2 illustrates the mailing tube plug 40 removed from the mailing tube body. The mailing tube plug comprises a mailing tube plug end 60 which fits through the open end 30 of the mailing tube to seal the mailing tube. The mailing tube plug end 60 has a cross sectional area which fits within the mailing tube. The mailing tube plug end 60 may be secured to the open end 30 of mailing tube by a fitted connection, by a threaded connection, a snap fit connection, or any other suitable method, or a combination thereof. As illustrated, the mailing tube is cylindrical with a circular cross sectional shape. The mailing tube may have any other suitable cross sectional shape, in which case the mailing tube plug end is correspondingly shaped to fit within the mailing tube cross sectional area.

The mailing tube plug 40 also comprises an ornament engagement end 70, which as illustrated in FIG. 2, has a larger diameter than the mailing tube plug end 60. An engagement end bottom 72 may limit the depth that the tube plug end 60 can be interested in toe the tube body 20. In other embodiments, the ornament engagement end 70 need not have a larger diameter than the mailing tube plug end 60. The ornament engagement end 70 may have the same or smaller diameter than the mailing tube plug end 60. An ornament 50 is received within the ornament engagement end 70.

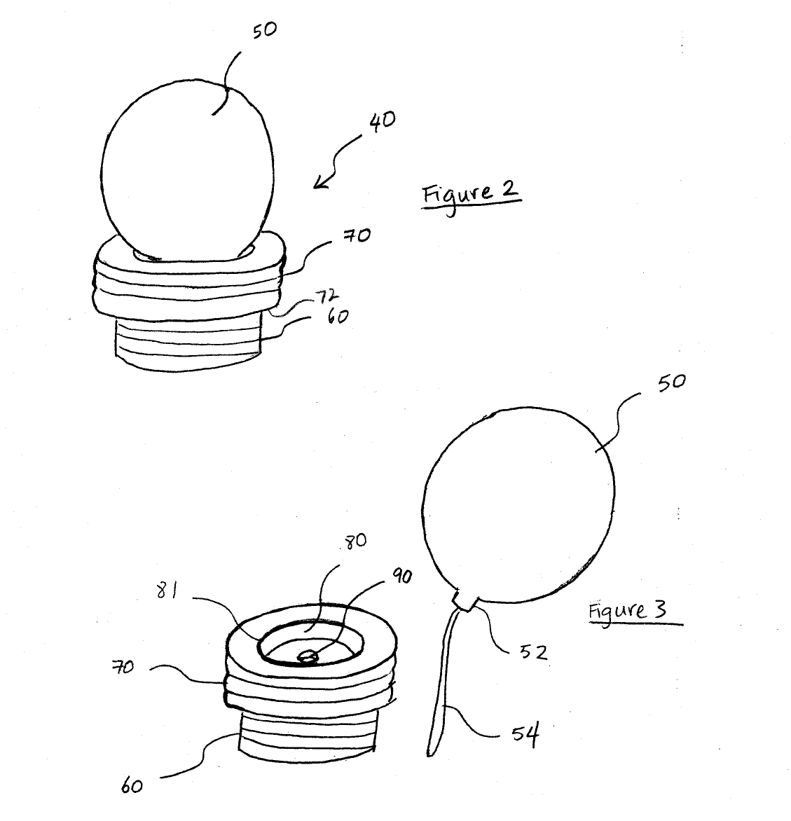

FIG. 3 illustrates the mailing tube plug with the ornament 50 removed. In the embodiment illustrated, the ornament engagement end 70 has a top surface comprising a first recessed region 80. The first recessed region 80 is circular. The perimeter of the first recessed region 80 may have a lip 81 which can also conform to the curvature of the ornament if so desired. Within the first recessed region 80 is a second recessed region 90, which shares the same central axis as the first recessed region 80, and the same central axis as the mailing tube plug 40. The first recessed region 80 is of a size and depth corresponding to the desired depth that the ornament is to be received in the recessed region. The ornament 50 comprises a neck 52 and an attachment device 54 such as a looped string. The second recessed region 90 is of a size and depth to receive the neck 52. The first recessed region 80, and the second recessed region 90 are configured to receive a portion of the ornament within the recessed region, and to receive the neck 52 of the ornament within the second recessed region 90. In other embodiments where the ornament does not have a neck 52, the second recessed region 90 may not be needed.

As illustrated in FIG. 4, a shaft 100 extends from the second recessed region through the mailing tube plug end 60. FIG. 4 illustrates the ornament 50 disposed in position over the ornament engagement end 70, with hidden sections shown in dashed lines. To secure the ornament 50 to the ornament engagement end 70, the attachment device 54 is passed through the shaft 100 to draw the ornament 50 against the first recessed region and the lip 81. Once the attachment device 54 is passed through the shaft, it is secured to prevent the ornament from moving out of the first recessed region 80 until desired by the user.

The attachment device 54 can be secured to prevent the looped string from loosening the ornament 50 from the first recessed region 80 by being pulled upwards along side the mailing tube plug end 60 and held place while the plug end is inserted in to the mailing tube body so that the attachment device 54 is bound between the tube plug end and the side wall of the tube body. In another embodiment, the attachment device can be secured with an adhesive, such as tape, to any part of the mailing tube plug 40, such as the bottom surface of the mailing tube plug end 60, or to the mailing tube body 20. In other embodiments, the attachment device can be looped around a notch, or a post, or any other mechanism for fastening string, that is on a surface of the mailing tube plug end 60.

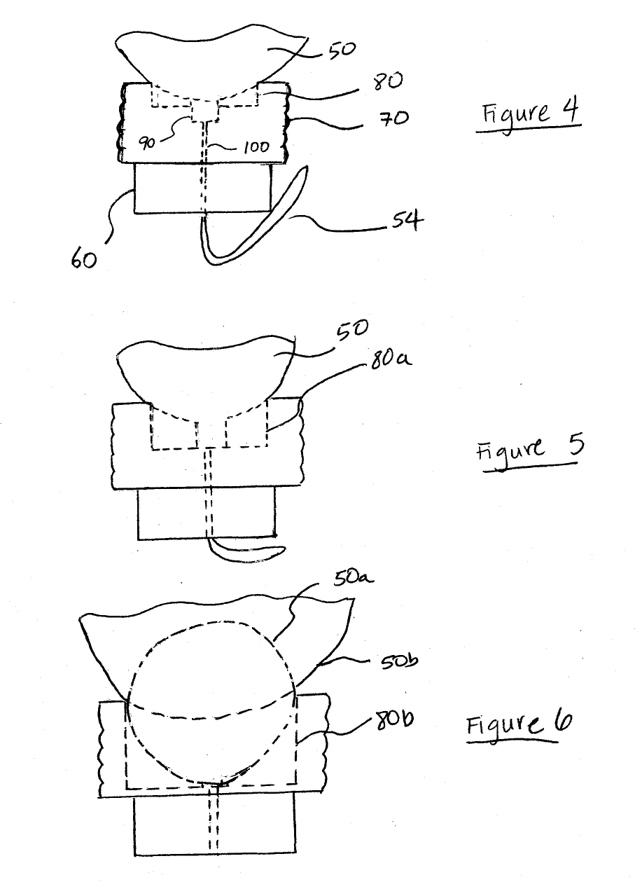

In one embodiment, as illustrated in FIG. 5, the first recessed region 80a does not have a second recessed region sized to receive the neck 52 of the ornament. The first recessed region 80a is of sufficient depth to receive the neck. In another embodiment, as illustrated in FIG. 6, the recessed region 80b may be of sufficient depth to accommodate various sizes of ornaments 50a, 50b. As illustrated in FIG. 6, the smaller ornament 50a would have a greater portion of the ornament within the recessed region 80b than the larger ornament 50b.

In use, the decorative mailing tube plug 40 is used to close a mailing tube with contents for delivery. Once the recipient receives the mailing tube, the mailing tube plug 40 is removed to access the delivered contents. The recipient can also remove the ornament from the mailing tube plug and use the ornament separately as a decoration, such as by handing the ornament from a tree by the attachment device 54.

The ornament may be any suitable size or shape. The recessed region 80 for receiving the ornament may be any suitable size or shape which can receive at least portion of the ornament.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein, to the extent that the references are not inconsistent with the present disclosure.

The invention claimed is:

1. A decorative mailing tube plug system comprising:
a mailing tube;
a mailing tube plug having a mailing tube plug end and an ornament receiving end on the opposite side of the mailing tube plug end, said mailing tube plug end configured to fit within the mailing tube;
a first recessed region on the ornament receiving end;
a shaft in communication with the first recessed region, said shaft extending from the mailing tube plug end towards the first recessed region; and
an ornament removeably disposed within the recessed region, said ornament having an ornament attachment device which is strung through the shaft.

2. The system of claim 1 wherein the shaft terminates at the first recessed region.

3. The system of claim 1 wherein the first recessed region further comprises a second recessed region.

4. The system of claim 3 wherein the second recessed region is circular.

5. The system of claim 3 wherein the shaft terminates at the second recessed region.

6. The system of claim 5 wherein the ornament has a neck region, and said second recessed region is configured to receive the neck region.

7. The system of claim 6 wherein the first recessed region is configured to receive a portion of the ornament.

8. The system of claim 1 wherein the first region is configured to receive a portion of the ornament.

9. The system of claim 1 wherein the first recessed region is circular.

10. A method for decorating a mailing tube using a mailing tube plug with an ornament having a looped string, comprising the steps of:
providing a mailing tube plug having a first recessed region and a central shaft extending through at least a portion of the remaining depth of the mailing tube plug;
disposing the ornament within the first recessed region such that the side of the ornament with the looped string is within the first recessed region;
stringing the looped string through the central shaft;
pulling the on the looped string to press the ornament against the first recessed region;
securing the looped string to minimize the movement of the ornament against the first recessed region; and
disposing the mailing tube plug within the mailing tube to seal the mailing tube.

11. The method of claim 10 wherein the central shaft extends from the first recessed region through the remainder of the depth of the mailing tube plug.

12. The method of claim 10 wherein the first recessed region has a second recessed region; and wherein the central shaft extends from the second recessed region through the remainder of the depth of the mailing tube plug.

13. The method of claim 11 wherein the ornament has a neck region from which the looped string extends; and wherein the step of disposing the ornament within the first recessed region comprises disposing the neck region within the second recessed region.

14. The method of claim 10 wherein the step of securing the looped string comprises the step of tucking the looped string between the mailing tube plug and the mailing tube.

15. A mailing tube plug for a mailing tube, comprising:
a mailing tube plug end, said mailing tube plug end configured to fit within the mailing tube to seal the mailing tube;
an ornament receiving end on the opposite side of the mailing tube plug end;
a first recessed region on the ornament receiving end;
a shaft which extends from a recessed region to the mailing tube plug end; and
an ornament removeably disposed within the recessed region, said ornament having an ornament attachment device which is strung through the shaft.

16. The mailing tube plug of claim 15 further comprising a second recessed groin within the first recessed region.

17. The mailing tube plug of claim 16 wherein the first and second recessed regions are circular.

18. The mailing tube plug of claim 17 wherein the first and second recessed regions share the same central axis.

19. The mailing tube plug of claim 15 wherein the first recessed region is configured to receive a portion of the ornament.
